(19) United States
(12) Patent Application Publication
(10) Pub. No.: US 2003/0053169 A1
(43) Pub. Date: Mar. 20, 2003

(54) Optical transmitter, WDM optical transmission device and optical module

(75) Inventors: Hideyuki Nasu, Tokyo (JP); Takehiko Nomura, Tokyo (JP); Toshikazu Mukaihara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: THE FURUKAWA ELECTRIC CO., LTD., Tokyo (JP)

(21) Appl. No.: 10/163,529

(22) Filed: Jun. 7, 2002

(30) Foreign Application Priority Data
Jun. 7, 2001 (JP) 2001-173150

(51) Int. Cl. H04J 14/02; H04B 10/04

(52) U.S. Cl. 359/133; 359/187

(57) ABSTRACT

The present invention provides an optical module having a light-emitting device for outputting a laser beam, a first temperature sensor disposed in proximity to the light-emitting device for sensing the temperature in the light-emitting device, a first temperature adjustment unit for adjusting the temperature in the light-emitting device, a wavelength monitor for receiving and monitoring the laser beam from the light-emitting device after passed through an optical filter, a second temperature sensor disposed in the wavelength monitor for sensing the temperature in the wavelength monitor, a second temperature adjustment unit for adjusting the temperature in the wavelength monitor, and a third temperature sensor disposed directly in or in proximity to the optical filter for sensing the temperature in the optical filter.

### BACKGROUND OF THE INVENTION

The present invention relates to an optical transmitter, wavelength division multiplexing (WDM) communication system and optical module. In the field of dense WDM, it is generally required that the wavelength of an optical signal is stable for long term. For such a purpose, there has been developed a technique of providing a wavelength monitoring function in an optical module.

### SUMMARY OF THE INVENTION

The present invention provides an optical transmitter comprising:

a light-emitting device for outputting a laser beam;

a first temperature adjustment unit for adjusting the temperature of said light-emitting device;

a wavelength monitor for receiving and monitoring the laser beam from said light-emitting device after it has passed through an optical filter; and

a second temperature adjustment unit for adjusting the temperature of said wavelength monitor,

wherein said optical filter is a optical interferometer formed of a medium which has its index of refraction variable depending on temperature and wherein the temperature of said optical filter is controlled by said second temperature adjustment unit into a temperature at which the optical transmission thereof at a predetermined wavelength will not coincide with either of the maximum or minimum level.

The present invention provides an optical module comprising:

a light-emitting device for outputting a laser beam;

a first temperature adjustment unit for adjusting the temperature of said light-emitting device;

a wavelength monitor for receiving and monitoring the laser beam from said light-emitting device after it has passed through an optical filter;

a second temperature adjustment unit for adjusting the temperature of said wavelength monitor; and

a package housing all the components mentioned above,

wherein said optical filter is a optical interferometer formed of a medium which has its index of refraction variable depending on temperature and wherein the temperature of said optical filter is controlled by said second temperature adjustment unit into a temperature at which the optical transmission thereof at a predetermined wavelength will not coincide with either of the maximum or minimum level.

The present invention provides an optical module comprising:

a light-emitting device for outputting a laser beam;

a first temperature sensor disposed in proximity to said light-emitting device for sensing the temperature in said light-emitting device;

a first temperature adjustment unit for adjusting the temperature of said light-emitting device;

a wavelength monitor for receiving and monitoring the laser beam from said light-emitting device after it has passed through an optical filter;

a second temperature sensor disposed in said wavelength monitor for sensing the temperature in said wavelength monitor;

a second temperature adjustment unit for adjusting the temperature in said wavelength monitor based on a value from said second temperature sensor; and

a third temperature sensor disposed directly in or in proximity to said optical filter for sensing the temperature in said optical filter.

The present invention provides an optical transmitter comprising:

an optical module including

a light-emitting device for outputting a laser beam,

a first temperature sensor disposed in proximity to said light-emitting device for sensing the temperature in said light-emitting device,

a first temperature adjustment unit for adjusting the temperature of said light-emitting device;

a wavelength monitor for receiving and monitoring the laser beam from said light-emitting device after it has passed through an optical filter,

a second temperature sensor disposed in said wavelength monitor for sensing the temperature in said wavelength monitor,

a second temperature adjustment unit for adjusting the temperature in said wavelength monitor based on a value from said second temperature sensor, and

a third temperature sensor disposed directly in or in proximity to said optical filter for sensing the temperature in said optical filter;

a control unit for locking the oscillation wavelength of the laser beam outputted from said light-emitting device at a predetermined lock wavelength, based on a signal outputted from said wavelength monitor; and

a correction unit for outputting a correction signal toward said control unit based on the temperature sensed by said third temperature sensor, said correction signal being used to instruct the correction of a shift in said lock wavelength in connection with the temperature characteristic of said optical filter.

The present invention provides an optical transmitter comprising:

an optical module including

a light-emitting device for outputting a laser beam,

a first temperature sensor disposed in proximity to said light-emitting device for sensing the temperature in said light-emitting device,

a first temperature adjustment unit for adjusting the temperature of said light-emitting device;

a wavelength monitor for receiving and monitoring the laser beam from said light-emitting device after it has passed through an optical filter,

a second temperature sensor disposed in said wavelength monitor for sensing the temperature in said wavelength monitor,

a second temperature adjustment unit for adjusting the temperature in said wavelength monitor based on a value from said second temperature sensor, and

a third temperature sensor disposed directly in or in proximity to said optical filter for sensing the temperature in said optical filter, said second temperature sensor also functioning as said third temperature sensor;

a control unit for locking the oscillation wavelength of the laser beam outputted from said light-emitting device at a predetermined lock wavelength, based on a signal outputted from said wavelength monitor; and

a correction unit for outputting a correction signal toward said control unit based on the temperature sensed by said third temperature sensor, said correction signal being used to instruct the correction of a shift in said lock wavelength in connection with the temperature characteristic of said optical filter.

The present invention provides a WDM optical transmission device comprising:

a plurality of optical transmitters, each of said optical transmitters comprising:

a light-emitting device for outputting a laser beam;

a first temperature adjustment unit for adjusting the temperature in said light-emitting device;

a wavelength monitor for receiving and monitoring the laser beam from said light-emitting device after passed through an optical filter; and

a second temperature adjustment unit for adjusting the temperature in said wavelength monitor,

wherein said optical filter is a optical interferometer formed of a medium which has its index of refraction variable depending on temperature and wherein the temperature of said optical filter is controlled by said second temperature adjustment unit into a temperature at which the optical transmission thereof at a predetermined wavelength will not coincide with either of the maximum or minimum level

and wherein optical signals outputted from said optical transmitters are multiplexed and transmitted.

The present invention provides a WDM optical transmission device comprising:

a plurality of optical transmitters, each of said optical transmitters comprising:

an optical module including

a light-emitting device for outputting a laser beam,

a first temperature sensor disposed in proximity to said light-emitting device for sensing the temperature in said light-emitting device,

a first temperature adjustment unit for adjusting the temperature of said light-emitting device;

a wavelength monitor for receiving and monitoring the laser beam from said light-emitting device after it has passed through an optical filter,

a second temperature sensor disposed in said wavelength monitor for sensing the temperature in said wavelength monitor,

a second temperature adjustment unit for adjusting the temperature in said wavelength monitor based on a value from said second temperature sensor, and

a third temperature sensor disposed directly in or in proximity to said optical filter for sensing the temperature in said optical filter;

a control unit for locking the oscillation wavelength of the laser beam outputted from said light-emitting device at a predetermined lock wavelength, based on a signal outputted from said wavelength monitor; and

a correction unit for outputting a correction signal toward said control unit based on the temperature sensed by said third temperature sensor, said correction signal being used to instruct the correction of a shift in said lock wavelength in connection with the temperature characteristic of said optical filter,

wherein optical signals outputted from said optical transmitters are multiplexed and transmitted.

The present invention provides a WDM optical transmission device comprising:

a plurality of optical transmitters, each of said optical transmitters comprising:

an optical module including

a light-emitting device for outputting a laser beam,

a first temperature sensor disposed in proximity to said light-emitting device for sensing the temperature in said light-emitting device,

a first temperature adjustment unit for adjusting the temperature of said light-emitting device;

a wavelength monitor for receiving and monitoring the laser beam from said light-emitting device after it has passed through an optical filter,

a second temperature sensor disposed in said wavelength monitor for sensing the temperature in said wavelength monitor,

a second temperature adjustment unit for adjusting the temperature in said wavelength monitor based on a value from said second temperature sensor, and

a third temperature sensor disposed directly in or in proximity to said optical filter for sensing the temperature in said optical filter, said second temperature sensor also functioning as said third temperature sensor;

a control unit for locking the oscillation wavelength of the laser beam outputted from said light-emitting device at a predetermined lock wavelength, based on a signal outputted from said wavelength monitor; and

a correction unit for outputting a correction signal toward said control unit based on the temperature sensed by said third temperature sensor, said correction signal being used to instruct the correction of a shift in said lock wavelength in connection with the temperature characteristic of said optical filter,

wherein optical signals outputted from said optical transmitters are multiplexed and transmitted.

### BRIEF DESCRIPTION OF THE DRAWINGS

FIG. 1 is a plan cross-sectional view of an optical module constructed according to the first embodiment of the present invention.

FIG. 2 is a side cross-sectional view of the optical module shown in FIG. 1.

FIG. 3 is a graph illustrating a process of correcting the shift in the lock wavelength.

FIG. 4 is a side cross-sectional view of an optical module constructed according to the second embodiment of the present invention.

FIG. 5 is a side cross-sectional view of an optical module constructed according to the third embodiment of the present invention.

FIG. 6 is a plan cross-sectional view of an optical module constructed according to the fourth embodiment of the present invention.

FIG. 7 illustrates a WDM optical transmission device usable in a wavelength division multiplexing communication system constructed according to the fifth embodiment of the present invention.

FIG. 8 illustrates the structure of an optical module constructed according to the prior art.

FIG. 9 is a block diagram illustrating the layout of a control unit.

FIG. 10 is a graph illustrating the aged deterioration in a laser diode.

FIG. 11 is a graph illustrating the relationship between the injected current and the oscillation wavelength when the temperature of an LD carrier in a laser diode is maintained constant.

FIG. 12 is a graph illustrating the relationship between the wavelength characteristics and the lock wavelength in an optical filter.

FIG. 13 is a graph illustrating the shift of the lock wavelength due to variations in the temperature of the optical filter.

FIG. 14 is a graph illustrating the relationship between the injected current and the lock wavelength when an optical monitor is activated.

FIG. 15 is a graph illustrating the wavelength discrimination characteristics of an optical filter (etalon filter).

FIG. 16 is a graph illustrating the relationship between the temperature of a casing and the temperature of a filter.

FIG. 17 is a graph illustrating the relationship between the wavelength and the PD current of the wavelength monitor for such a purpose of describing the problem in the prior art.

FIG. 18 is a plan view showing an optical module constructed according to the sixth embodiment of the present invention.

FIG. 19 is a graph illustrating the control of temperature in the optical filter (etalon filter).

### DETAILED DESCRIPTION

Several embodiments of the present invention will now be described with reference to the drawings in comparison with the prior art.

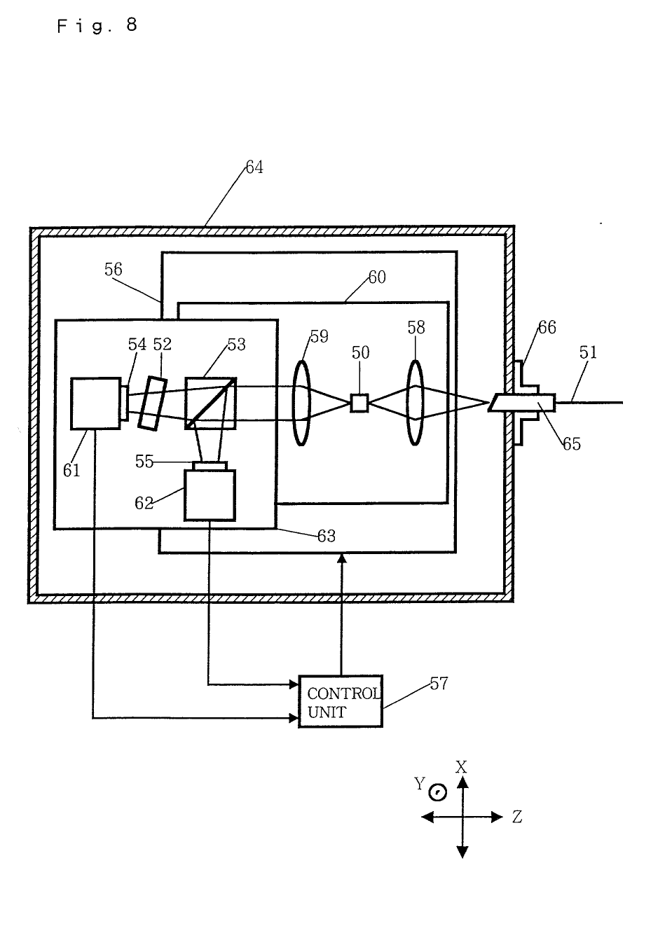

FIG. 8 illustrates the layout of an optical module according to the prior art, disclosed in Japanese Patent Laid-Open Application 2000-56185.

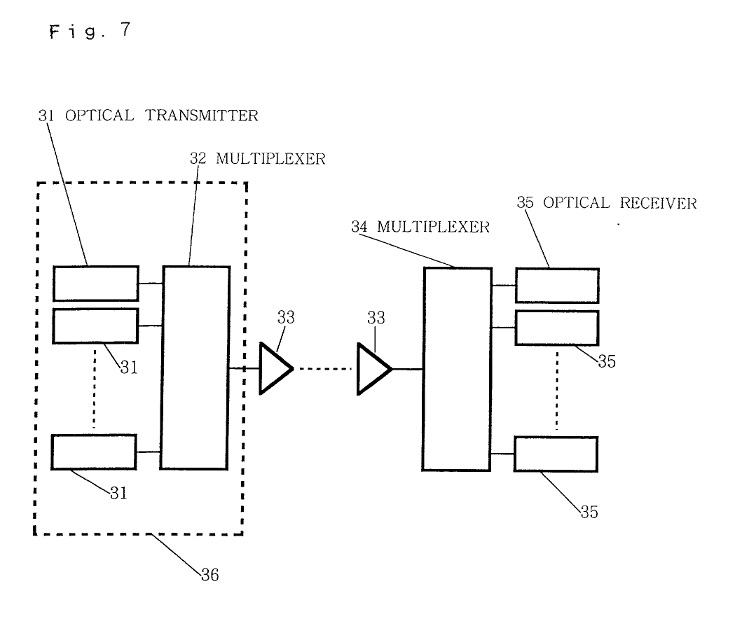

The optical module of the prior art comprises a light-emitting device 50 formed by a semiconductor laser diode for outputting a laser beam of a predetermined oscillation wavelength or other component, an optical fiber 51 optically coupled with the light-emitting device 50 and for externally delivering a laser beam outputted from the front (or right as viewed in FIG. 7) facet of the light-emitting device 50, an optical filter 52 having substantially the same cut-off wavelength as the oscillation wavelength of the light-emitting device 50, a beam splitter 53 including a half-mirror for dividing a laser beam outputted from the back (or left as viewed in FIG. 8) facet of the light-emitting device 51 into two laser beam portions, a first light-receiving device 54 consisting of a photodiode or the like for receiving one of the laser beam portions divided by the beam splitter 53 after passed through the optical filter 52, a second light-receiving device 55 consisting of a photodiode or the like for receiving the other laser beam portion, and a thermo-module 56 for adjusting the temperature in the light-emitting device 50. The optical module is also connected with a control unit 57. The control unit 57 is adapted to control the thermo-module 56 to regulate the wavelength in the light-emitting device 50, based on the PD currents outputted from the first and second light-receiving devices 54, 55.

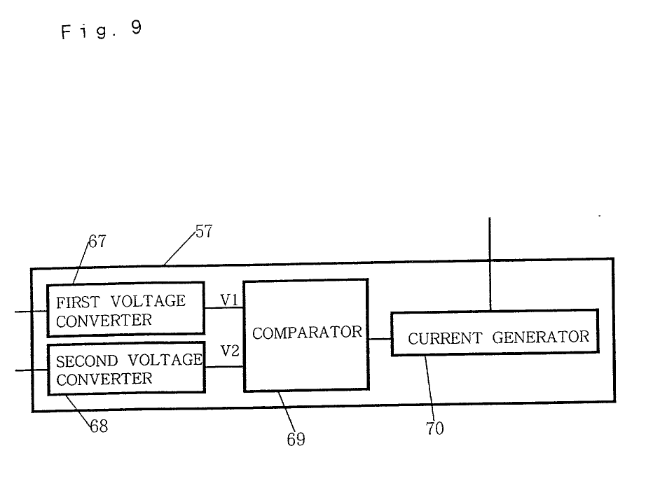

FIG. 9 is a block diagram illustrating the layout of a control unit. As shown in FIG. 9, the control unit 57 may comprise, for example, a first voltage converter 67 for transducing a first PD current outputted from the first light-receiving device 54 into a first voltage V1, a second voltage converter 68 for transducing a second PD current outputted from a second light-receiving device 55 into a second voltage V2, a comparator 69 for outputting the difference or ratio between the first and second voltages V1, V2 respectively outputted from the first and second voltage converters 67, 68 as a control signal, and a thermo electric cooler (TEC) current generator 70 for outputting a temperature control current which is used to increase or decrease the temperature of the thermo-module 56 based on the control signal from the comparator 69.

Between the light-emitting device 50 and the optical fiber 51 is disposed a condensing lens 58 for focusing the laser beam from the front facet of the light-emitting device 50 into the optical fiber 51. Between the light-emitting device 50 and the beam splitter 53 is disposed a collimating lens 59 for collimating the laser beam outputted from the back facet of the light-emitting device 50.

The light-emitting device 50, condensing lens 58 and collimating lens 59 are fixedly mounted on an LD carrier 60. The first and second light-receiving devices 54, 55 are fixedly mounted on first and second PD carriers 61, 62, respectively.

The beam splitter 53, optical filter 52, first and second PD carriers 61, 62 are fixedly mounted on a metal substrate 63. The metal substrate 63 is fixedly mounted on the surface of the LD carrier 60 which is in turn fixedly mounted on the thermo-module 56.

The light-emitting device 50, beam splitter 53, optical filter 52, condensing lens 58, collimating lens 59, LD carrier 60, first PD carrier 61, second PD carrier 62, metal substrate 63 and thermo-module 56 are housed within a package 64. The tip end of the optical fiber 51 is held by a ferrule 65 which is fixedly mounted on the side of the package 64 through a sleeve 66.

The laser beam outputted from the front facet of the light-emitting device 50 is condensed by the condensing lens 58 and then enters the optical fiber 51 held by the ferrule 65 before being externally delivered.

On the other hand, the laser beam outputted from the back facet of the light-emitting device 50 is collimated by the collimating lens 59 and then divided by the beam splitter 53 into a beam portion traveling in the Z-axis direction (or the direction of transmission) and another beam portion traveling in the X-axis direction perpendicular to the Z-axis direction (or the direction of reflection). The laser beam portion divided in the Z-axis direction will be received by the first light-receiving device 54 while the laser beam portion divided in the X-axis direction will be received by the second light-receiving device 55.

The PD currents outputted from the first and second light-receiving devices 54, 55 are inputted into the control unit 57. Based on the values of the inputted PD currents, the control unit 57 controls the regulating temperature of the thermo-module 56 to regulate the wavelength of the light-emitting device 50.

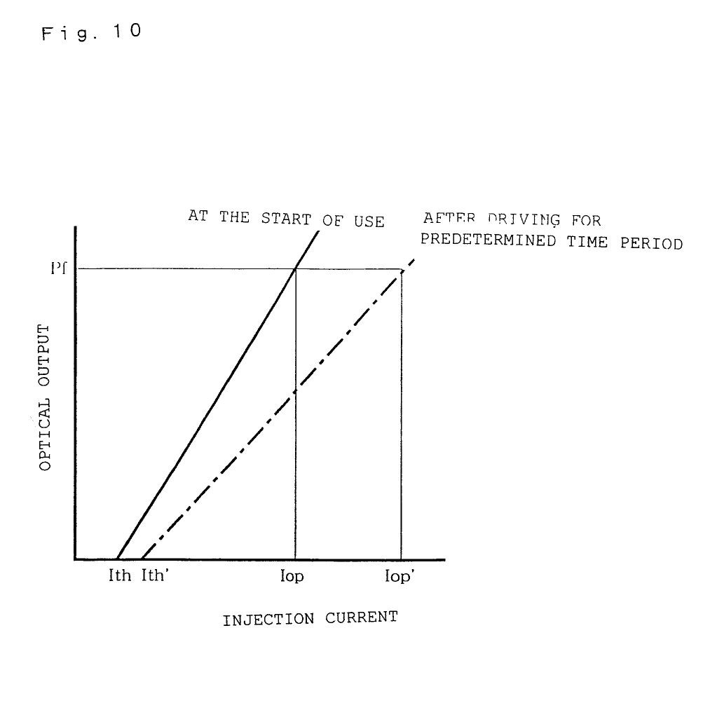

FIG. 10 is a graph illustrating the aged deterioration in a laser diode. As shown in FIG. 10, the optical module including the laser diode has its threshold Ith when it is first activated. An auto-power-control (APC) circuit is activated to provide a predetermined light output Pf.

Current injected into the laser diode for providing the light output Pf when the optical module is first activated is lop. As the laser diode continues to be used for long term, its characteristics will be deteriorated. The threshold increases from its initial level to Ith′ on expiration of a predetermined term. Further, the current injected into the laser diode for providing the light output Pf also increases to Iop′.

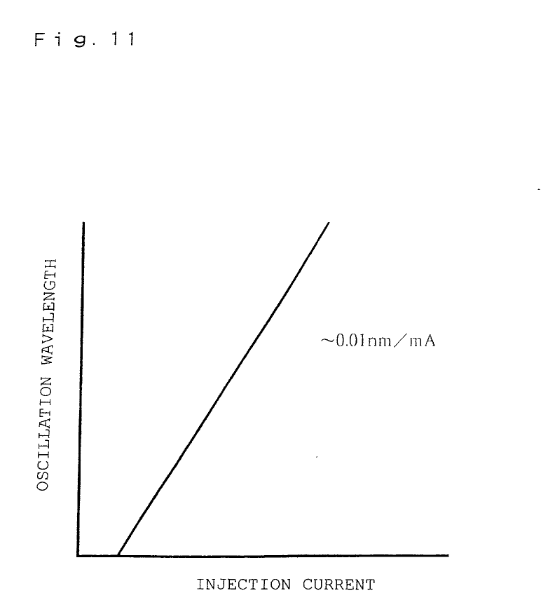

As shown in FIG. 11, the oscillation wavelength of the laser diode has an injection-current dependency when the temperature in the LD carrier (sub-mount) is maintained constant. This dependency is usually equal to about 0.01 nm/mA. Thus, the oscillation wavelength is shifted longer when the temperature of the LD carrier is maintained constant and if the aged deterioration occurs in the laser diode.

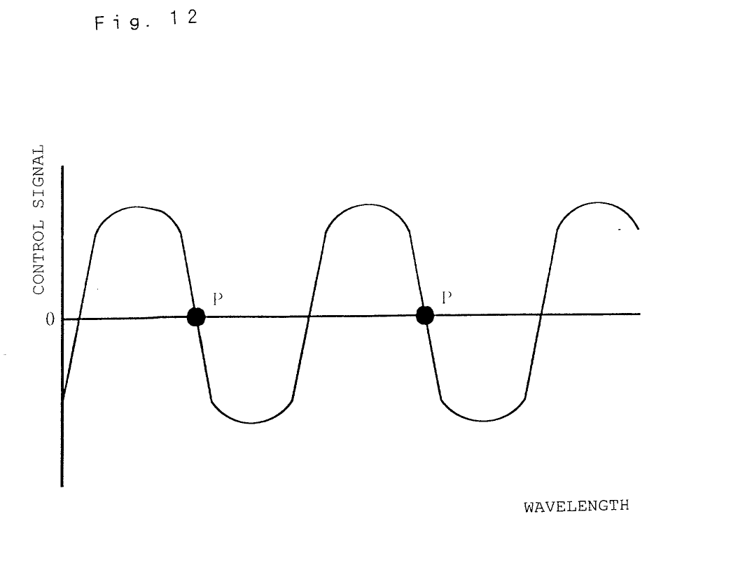

The optical filter is used to lock the wavelength of the laser diode having such a characteristic. Namely, the oscillation wavelength of the optical module is fixed at such a wavelength lock point as shown in FIG. 12 by monitoring the wavelength and regulating the temperature of the LD carrier on which the laser diode is mounted through the thermo-module. When the injected current is increased due to the aged deterioration of the laser diode, the oscillation wavelength is shifted longer by the increased temperature of the active layer in the laser diode. The temperature of the LD carrier can be reduced by the thermo-module since the wavelength shift is compensated by driving the wavelength monitor using the optical filter.

In the meantime, the optical filter may be formed of quartz with its optical transmission property having a temperature dependency (which will be referred to simply “temperature characteristic”). For example, a certain optical filter may have its wavelength-optical transmission characteristic shifted shorter at a rate of 0.01 nm/° C.

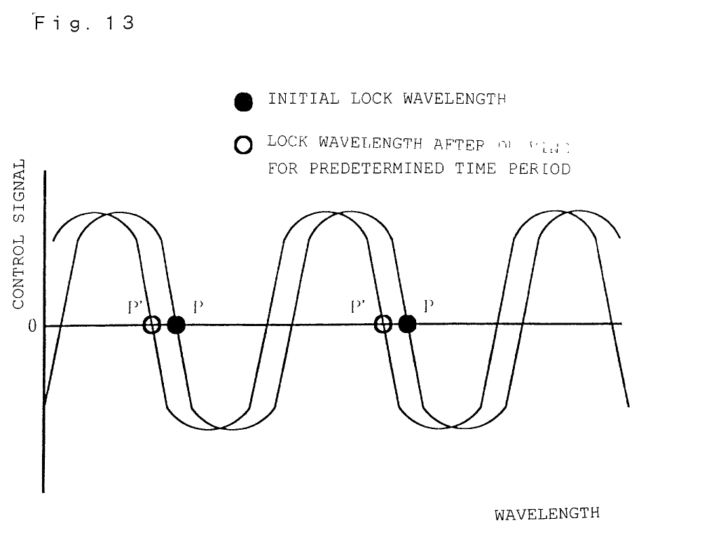

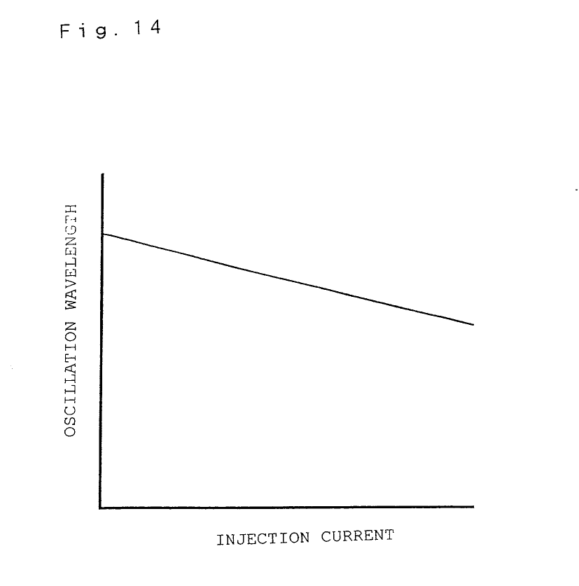

The optical module of the prior art may thermally connected to maintain the temperatures of the light-emitting device, optical filter 50, 52 substantially equal to each other, as shown in FIG. 8. If the temperature of the LD carrier on which the light-emitting device 50 is placed is reduced, thus, the temperature of the optical filter 52 is also reduced, thereby changing the characteristic of the optical filter 52. In other words, if the light-emitting device 50 is aged-deteriorated when a predetermined term is expired from start of the wavelength monitor, the current injected into the light-emitting device 50 is increased to raise the temperature thereof. At this time, the thermo-module 56 is controlled by the control unit 57 to compensate the shifted wavelength. Thus, the temperature of the light-emitting device 50 is reduced to decrease the temperature of the optical filter. When the temperature of the optical filter is reduced, the initial wavelength characteristic will not be provided. The characteristic of the optical filter will wholly be shifted shorter, as shown in FIG. 13. In FIG. 13, black circles represent initial lock wavelength P while white circles represent lock wavelength P′ after the optical filter has been driven for a predetermined time period. As will be apparent from this fact, the prior art could not provide a light having its desired wavelength since the lock wavelength has been shifted from P to P′. The relationship between the injected current and the lock wavelength when the wavelength monitor is driven is as shown in FIG. 14. The oscillation wavelength has a current dependency.

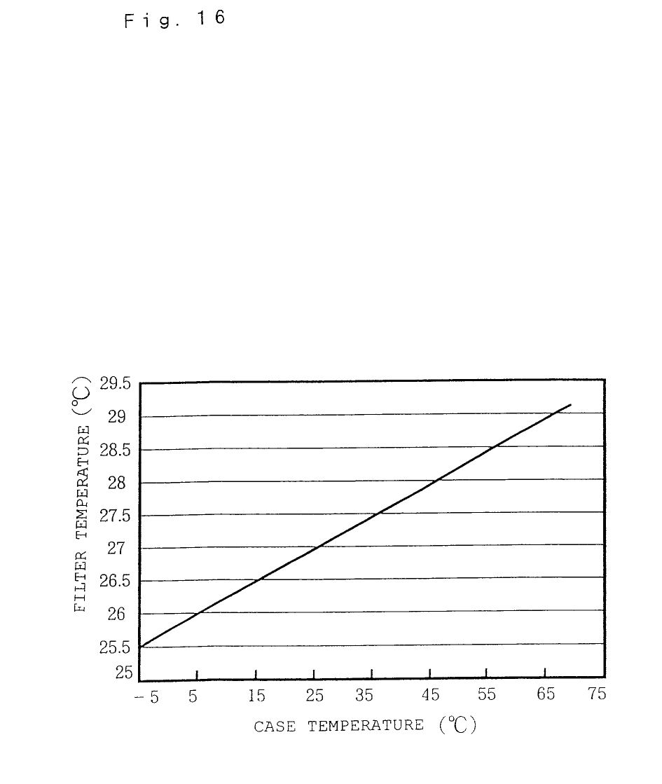

Even when the Peltier module 56 on which the optical filter is mounted is maintained in constant temperature, the temperature within the optical module is varied depending changes in the external environment temperature or the amount of current consumed by the optical module. Therefore, the optical filter will be influenced by the changes in the environment temperature through the side of the optical filter which is in direct contact with the Peltier module. For example, thus, the temperature of the optical filter will be changed as shown in FIG. 16.

The shifting of lock wavelength associated with the changed temperature of such an optical filter is undesirable for the dense WDM system required to have its stable wavelength since it causes the signal to be deteriorated through cross-talk.

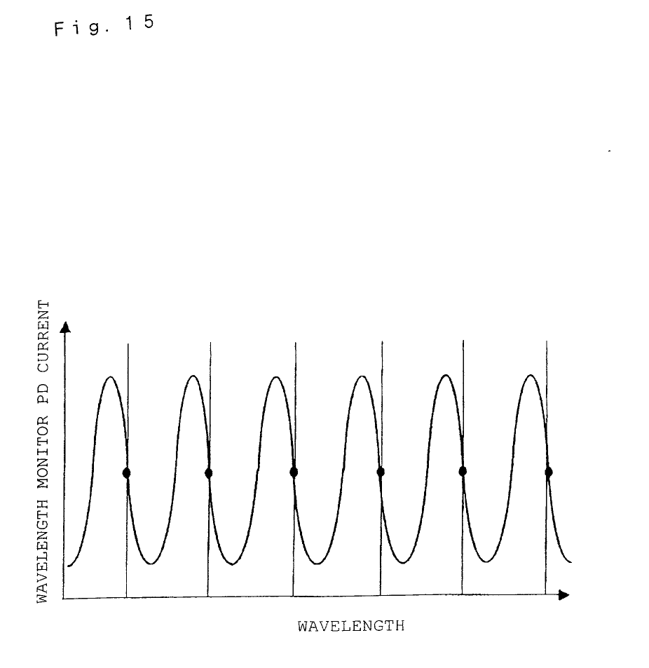

The dense WDM system is strictly required to prevent the shifting of wavelength in the respective one of the optical signal wavelengths since the spacing between the wavelengths of the adjacent optical signals is smaller. Thus, it must lock the oscillation wavelength with more accuracy. For example, if the optical filter for arranging optical signals is an etalon filter having such a wavelength discrimination characteristic as shown in FIG. 15, it must be configured to overlap the near-center area of the slope on a predetermined wavelength such that the optical signals can be arranged with a constant spacing between wavelengths.

In the meantime, for example, Japanese Patent Laid-Open Application 2001-44558 proposes a technique of detecting the temperature of etalon, sending a correcting signal from a correction unit to a control section and then performing the correction of temperature. In general, the etalon filter has a temperature characteristic. One of various materials used to form the etalon is crystal having its smaller temperature characteristic. The crystal is also used in the above-mentioned Japanese Patent Laid-Open Application. It is known that the temperature characteristic of the crystal etalon is 5 pm/° C.

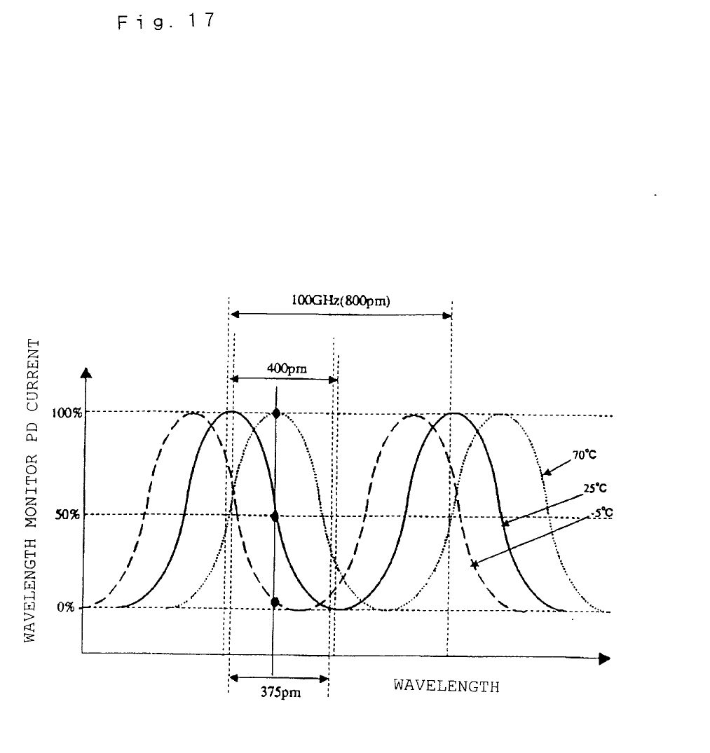

As shown in FIG. 17, the wavelength locked through the temperature correction and the locking point on the slope when the crystal etalon having its spacing of, for example, 100 GHz (800 pm) is used to lock the wavelength may be represented as the illustrated relationship. By performing the temperature correction, the locked wavelength and the locking point on the slope will actively move on the slope.

On the other hand, in the field of WDM and particularly dense WDM, much many laser modules having different light-emitting wavelengths are required. However, it is not realistic to produce all these lasers having their different wavelengths with different specifications. It is thus desirable that one laser module has several adjustable wavelengths required and such a characteristic as can accommodate to at least two wavelengths. In order to enable such an adjustment of wavelength, there is effective the etalon or the like in which its wavelength transmission characteristic has a repeatable cycle in association with the wavelengths of a laser beam required by the optical filter in the wavelength monitor section.

The etalon filter is designed to provide a pre-selected wavelength spacing suitable for WDM light communication and to cause the laser-emitting wavelength to include a predetermined control wavelength which is at the center of the wavelength transmission slope in the etalon filter. However, a problem is raised in that the locking point of the light-emitting wavelength in a laser to be controlled will be shifted from near the center of the wavelength transmission slope in the etalon filter because of any slight inclination created when the etalon filter is mounted or because of different lengths of the resonator in the etalon filter created due to the incident angle of a laser beam entering the etalon filter on alignment of the lens or light dividing member.

If a predetermined wavelength at which the laser oscillation wavelength is to be fixed exists near the maximum or minimum peak in the wavelength transmission characteristic of the etalon filter, the amount of light in the laser beam passing through the etalon filter is less changed in connection with the changed wavelength of the laser beam. It is thus difficult to detect the changed wavelength of the laser beam with accuracy. As a result, it is also difficult to control the wavelength of the laser beam in the stable manner.

The present invention is made for a purpose of overcoming the above-mentioned problem and has an object to provide an optical module, optical transmitter and WDM optical transmission device which can maintain the temperature of a wavelength monitor including an optical filter with a temperature characteristic at an appropriate level for providing the wavelength characteristic of the optical filter suitable for the light-emitting wavelength of a laser to be controlled and which can more accurately control the oscillation wavelength of the laser beam by correcting the shifted temperature of the optical filter created from the distribution of temperature due to the external environmental temperature.

Several embodiments of the present invention will now be described with reference to the drawings.

(First Embodiment)

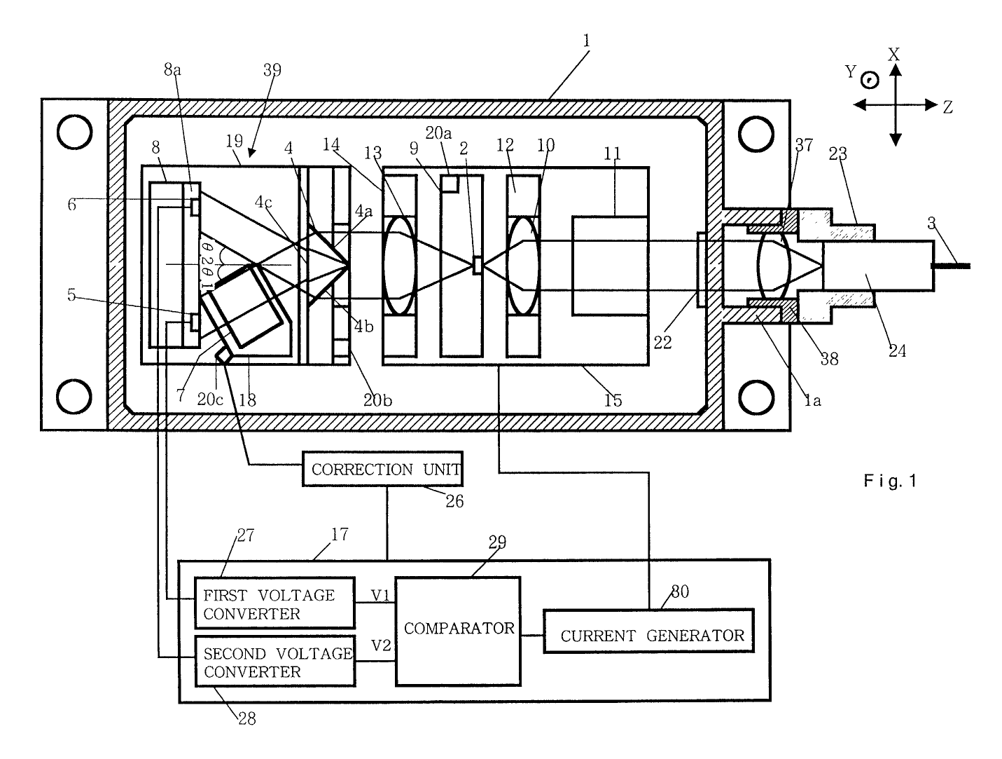

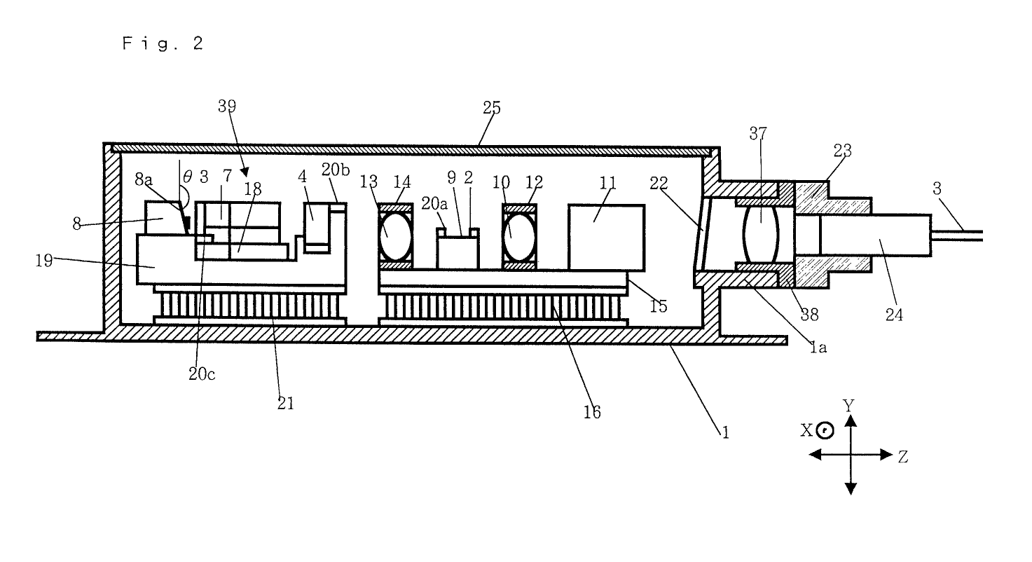

FIG. 1 is a plan cross-sectional view of an optical module constructed according to the first embodiment of the present invention while FIG. 2 is a side cross-sectional view of the optical module shown in FIG. 1.

As shown in FIGS. 1 and 2, an optical module constructed according to the first embodiment of the present invention comprises a hermetically sealed package 1, an light-emitting device 2 such as a semiconductor laser device for outputting laser beams, said light-emitting device 2 being housed within the package 1, an optical fiber 3 for receiving the laser beam outputted from the front (or right as viewed in FIG. 1) facet of the light-emitting device 2 before it is externally delivered, and a wavelength monitor 39 for mentoring the wavelengths of the laser beams from the light-emitting device 2.

The wavelength monitor 39 comprises a prism (or beam splitting member) 4 for dividing a monitoring laser beam outputted from the back (or left as viewed in FIG. 1) facet of the light-emitting device 2 into two beam portions which are respectively inclined relative to the optical axis by given angles θ1 and θ2 respectively less than 90 degrees, a first light-receiving device 5 such as a photodiode for receiving one of the laser beam portions divided by the prism 4, a second light-receiving device 6 such as a photodiode for receiving the other laser beam portion from the prism 4, an optical filter 7 disposed between the first light-receiving device 5 and the prism 4 and for transmitting only a laser beam in a predetermined wavelength band, and a PD carrier (mounting member) 8 on which the first and second light-receiving devices 5, 6 are mounted in the same plane (or the same attaching surface 8a herein).

The light-emitting device 2 is fixedly mounted on an LD carrier 9. The LD carrier 9 also carries a first temperature sensor 20a for sensing the temperature in the light-emitting device 2.

Between the light-emitting device 2 and the optical fiber 3 is disposed a collimating lens (or first lens) 10 for collimating the laser beam outputted from the front facet of the light-emitting device 2 and an optical isolator 11 for blocking any reflective light return back from the optical fiber 3. The collimating lens 10 is held by a first lens holder 12.

Between the light-emitting device 2 and the prism 4 is disposed another collimating lens 13 for collimating a monitoring laser beam outputted from the back facet of the light-emitting device 2. The collimating lens 13 is held by a second lens holder 14.

The LD carrier 9, optical isolator 11, first lens holder 12 and second lens holder 14 are fixedly mounted on a first base 15 which is in turn fixedly mounted on a first temperature adjustment unit 16 consisting of a thermo-module for cooling the light-emitting device 2 (see FIG. 2). The first temperature adjustment unit 16 is controlled to maintain the temperature sensed by the first temperature sensor 20a constant.

PD currents outputted from the first and second light-receiving devices 5, 6 are inputted into a control unit 17 which in turn uses the values of the inputted PD currents to control the regulating temperature in the first temperature adjustment unit 16 such that the wavelengths of the laser beams outputted from the light-emitting device 2 will be controlled.

The control unit 17 comprises a first voltage converter 27 for transducing a first PD current outputted from the first light-receiving device 5 into a first voltage V1, a second voltage converter 28 for transducing a second PD current outputted from the second light-receiving device 6 into a second voltage V2, a comparator 29 for outputting the difference or ration between the first voltage V1 outputted from the first voltage converter 27 and the second voltage V2 outputted from the second voltage converter 28 as a control signal, and a current generator 30 for outputting a temperature control current used to control the regulating temperature in the first temperature adjustment unit 16, based on the control signal outputted from the comparator 29. Any amplifier (not shown) for amplifying the first and second voltages V1, V2 from the first and second voltage converters 27, 28 may be provided in the forward stage of the comparator 29.

The prism 4 has two light-incident sloped faces 4a and 4b forming a beveled roof and a horizontal face 4c for providing a planer light-exit face. The laser beam from the light-emitting device 2 enters the interior of the prism 4 through these two sloped faces 4a and 4b thereof and is then divided into two laser beam portions.

All the faces of the prism 4 are coated with anti-reflection (AR) films to suppress the reflection of laser beam. It is preferred that the laser beam portions divided by the prism 4 are inclined substantially by the same angle (θ1, θ2) ranging, for example, between 15 degrees and 45 degrees. This is because the light-receiving positions of the first and second light-receiving devices 5, 6 can easily be determined.

The optical filter may be formed of etalon or the like and is fixedly mounted on a filter holder 18 through low-melting glass or soldering. The filter holder 18 includes a third temperature sensor 20c formed of thermistor or the like. The third temperature sensor 20c can accurately measure the changed temperature of the optical filter 7 since the third temperature sensor 20c is positioned in close proximity to the optical filter 7.

The attaching surface 8a of the PD carrier 8 for the first and second light-receiving devices 5, 6 is inclined relative to the direction of incident laser beam by an angle θ3 exceeding 90 degrees (see FIG. 2). The angle θ3 of the attaching surface 8a is preferably equal to or larger than 95 degrees for reducing the reflectively returned light and providing a good characteristic. Since PD current sufficient to be coupled with the photodiode cannot be obtained if the attaching surface 8a is too much inclined relative to the direction of incident laser beam, it is further preferred that the angle θ3 is equal to or smaller than 135 degrees to suppressing the deterioration of coupling efficiency within 3 dB. It is thus most preferred that the angle θ3 of the attaching surface 8a is between 95 degrees and 135 degrees.

The prism 4, filter holder 18 and PD carrier 8 are fixedly mounted on a second base 19 which includes a second temperature sensor 20b for sensing the temperature in a wavelength monitor 39.

As shown in FIG. 2, the second base 19 is fixedly mounted on a second temperature adjustment unit 21 consisting of a thermo-module. The second temperature adjustment unit 21 is controlled to maintain the temperature sensed by the second temperature sensor 20b constant.

One side of the package 1 includes a flange section 1a formed thereon. Within the interior of the flange section 1a are provided a window portion 22 onto which the laser beam enters after passed through the optical isolator 11 and a condensing lens (or second lens) 37 for condensing the laser beam onto the end face of the optical fiber 3. The condensing lens 37 is held by a third lens holder 38 fixedly mounted on the outer end of the flange section 1 a through YAG laser welding. A metal slide ring 23 is fixedly mounted on the outer end of the third lens holder 38 through YAG laser welding.

The optical fiber 3 is held by a ferrule 24 which is fixedly mounted in the interior of the slide ring 23 through YAG laser welding.

The open top of the package 1 is closed by a lid 25 (see FIG. 2). The periphery of the lid 25 is resistance-welded to the package 1 to hermetically seal the package 1.

The laser beam outputted from the front facet of the light-emitting device 2 is collimated by the collimating lens 10. The collimated beam is fed onto the condensing lens 37 through the optical isolator 11 and window 22 and then condensed by the condensing lens 37 onto the end face of the optical fiber 3 held by the ferrule 24 before externally delivered therefrom.

On the other hand, the monitoring laser beam outputted from the back facet of the light-emitting device 2 is collimated by the collimating lens 13 and then enters the prism 4. The collimated beam is then divided by the prism 4 into two laser beam portions which are inclined relative to the optical axis by predetermined angles θ1 and θ2, respectively.

One of the laser beam portions divided by the prism 4 enters the optical filter 7 through which only the laser beam part in a predetermined wavelength band passes, the passed beam part being then received by the first light-receiving device 5. The other laser beam portion is received by the second light-receiving device 6. PD currents outputted from the first and second light-receiving devices 5, 6 are inputted into the control unit 17. The control unit 17 controls the first temperature adjustment unit 16 based on the differential voltage (or voltage ratio) between the two inputted PD currents such that the first temperature adjustment unit 16 regulates the temperature sensed by the first temperature sensor 20a to maintain the wavelength of the laser beam outputted from the light-emitting device 2 constant.

Although the optical parts such as the optical filter 7, prism 4 and others are controlled by the second temperature adjustment unit 21 to maintain the temperatures of these parts constant since they have their temperature dependencies, the optical parts are always influenced by the changed temperature outside the module. Thus, the control of temperature in the second temperature adjustment unit 21 may be unable to follow the changed temperature in the optical parts. If one of such optical parts (particularly, the optical filter 7) is changed in temperature, the output values of the two PD currents may also be changed to more or less vary the wavelengths of the laser beams outputted from the light-emitting device 2.

To overcome such a problem, the first embodiment further comprises a correction unit 26 which includes a circuit for receiving a temperature detection signal outputted from the third temperature sensor 20c located in proximity to the optical filter 7 and for outputting a temperature correction signal toward the control unit 17.

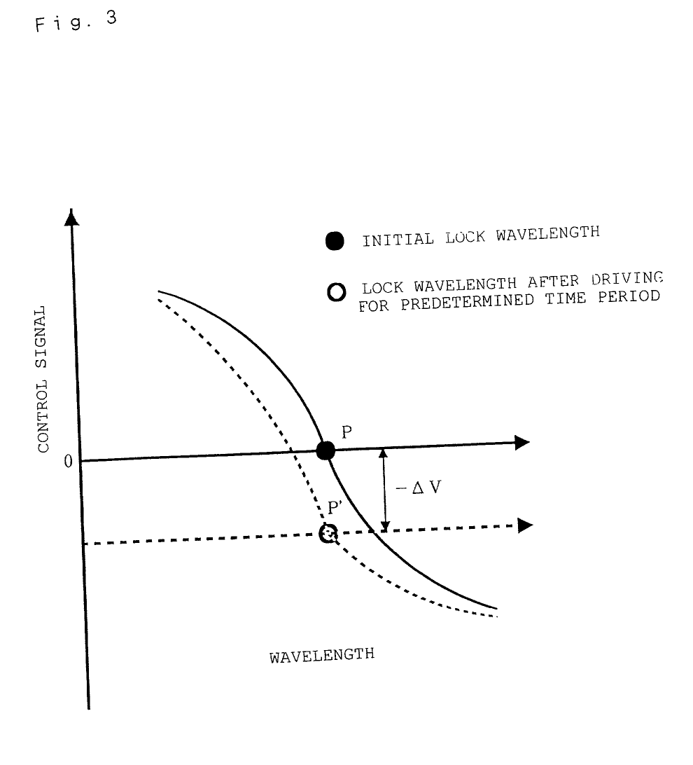

The correction unit 26 outputs a correction signal for correcting a shifted lock wavelength in connection with the temperature characteristic of the optical filter 7 toward the control unit 17, based on the temperature sensed by the third temperature sensor 20c. More particularly, the correction unit 26 is adapted to input a predetermined voltage corresponding to the temperature of the optical filter 7 into the comparator 29 of the control unit 17 and causes the voltage of the control signal to offset by the first mentioned voltage for correcting the shift of wavelength due to the temperature characteristic of the optical filter 7. As shown in FIG. 3, for example, the wavelength characteristic may be shifted shorter after passage of a predetermined time period counted from initiation of the optical filter 7, due to the temperature characteristic of the optical filter 7. To maintain the initial lock wavelength, the temperature characteristic of the optical filter 7 is first taken. Next, the temperature of the optical filter 7 is sensed by the second temperature sensor 20. The correction unit 26 then outputs an appropriate correction voltage corresponding to the sensed change of temperature toward the comparator 29 in the control unit 17. The correction voltage is then used to offset the zero-voltage point in the control voltage signal. When the wavelength characteristic is shifted by the changed temperature in the optical filter 7 after it is driven from the initial state or zero-voltage point for a predetermined time period in FIG. 3, such a changed temperature is sensed to output a voltage ΔV corresponding to it. Thus, the zero-voltage point is newly set at a point wherein it is reduced from its initial state by ΔV. Since the wavelength will be locked at the new zero-voltage point, the wavelength lock can stably be performed without change of the wavelength from its initial state.

Voltage values to be offset may be set by linearly calculating optimal voltage values previously measured for two temperatures or may be read out from a database in which optimal offset voltage values relating to temperatures have been stored.

According to the first embodiment of the present invention, the temperature in the wavelength monitor 39 including the optical filter 7 can be stabilized since the optical filter 7 having the temperature characteristic is controlled in temperature separately of the light-emitting device 2. In addition, the oscillation wavelength of the laser beam can more accurately be controlled since the shift in the wavelength monitor signal can be compensated by the third temperature sensor 20c for sensing the temperature of the optical filter 7 even though the temperature of the optical filter 7 is shifted due to the distribution of temperature on the second temperature adjustment unit 21 based on the external temperature environment.

The temperature control of the first temperature adjustment unit 16 and the temperature correction of the optical filter 7 may be performed as by using the average of both values from the second and third temperature sensors 20b, 20c.

(Second Embodiment)

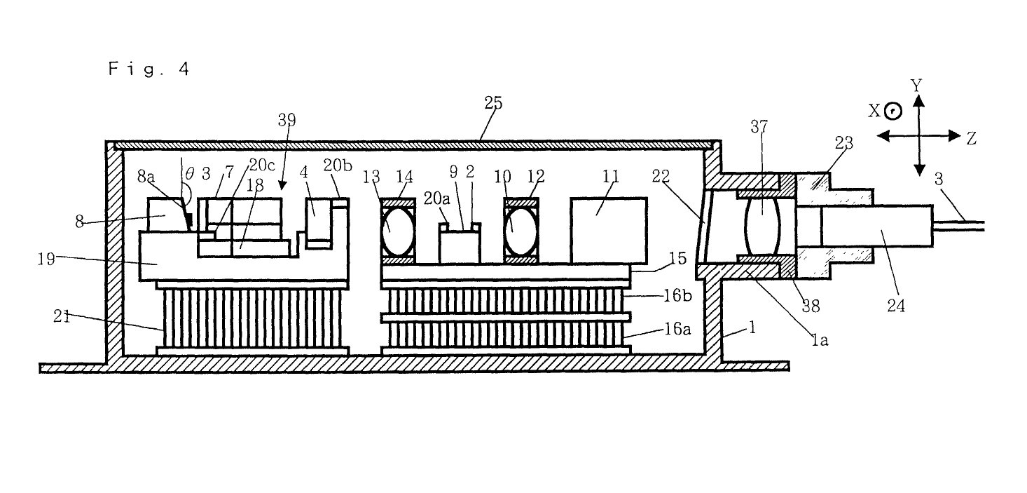

FIG. 4 is a side cross-sectional view of an optical module according to the second embodiment of the present invention. As shown in FIG. 4, the second embodiment is characterized by that the first temperature adjustment unit 16 is configured by two thermo-modules 16a, 16b superposed one on another. The other features are similar to those of the first embodiment.

According to the second embodiment, the range of temperature control in the first temperature adjustment unit 16 can be widened since the first temperature adjustment unit 16 is configured by two thermo-modules 16a, 16b superposed one on another. This enables the variable range of wavelength in the light-emitting device 2 to be also widened.

The first temperature adjustment unit 16 may include three or more thermo-modules superposed one on another.

(Third Embodiment)

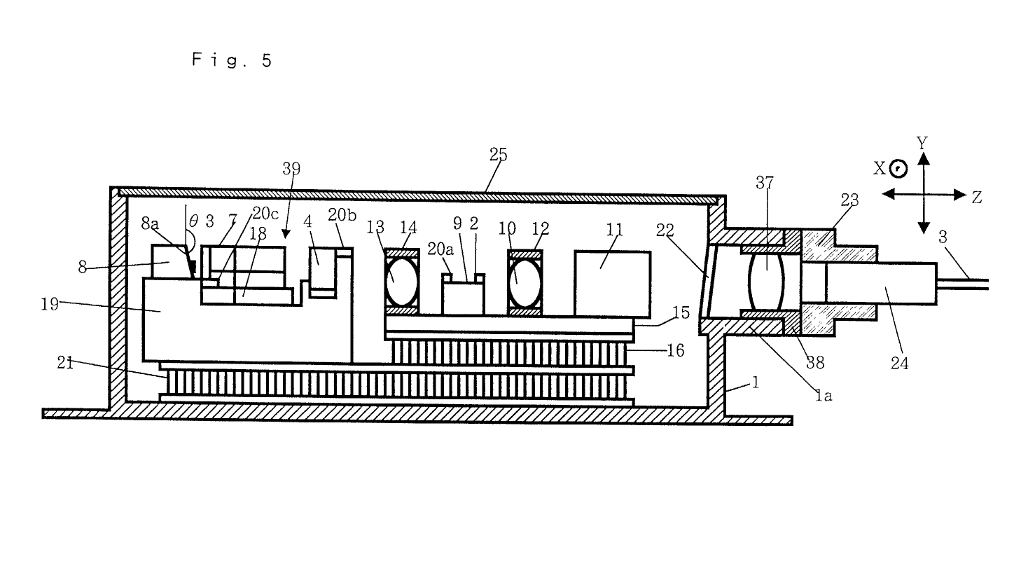

FIG. 5 is a side cross-sectional view of an optical module according to the third embodiment of the present invention. As shown in FIG. 5, the third embodiment is characterized by that the first temperature adjustment unit 16 is placed on the second temperature adjustment unit 21. The other features are similar to those of the first embodiment.

According to the third embodiment, the range of temperature control in the first temperature adjustment unit 16 can be widened since the first temperature adjustment unit 16 is placed on the first temperature adjustment unit 16. This enables the variable range of wavelength in the light-emitting device 2 to be also widened.

(Fourth Embodiment)

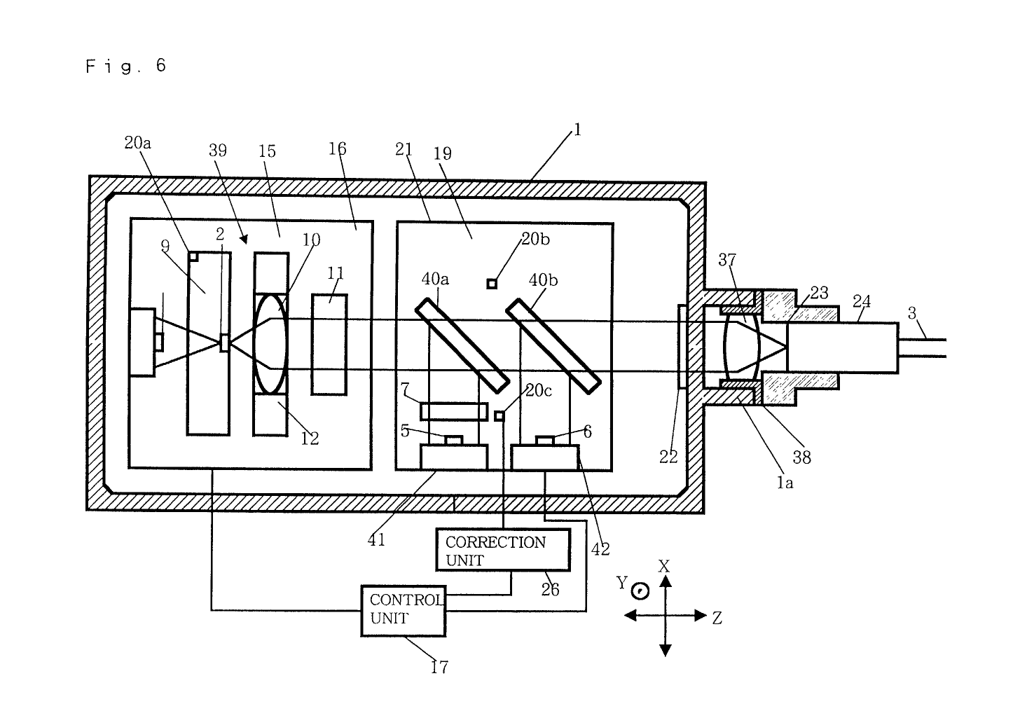

FIG. 6 is a plan cross-sectional view of an optical module according to the fourth embodiment of the present invention. As shown in FIG. 6, the fourth embodiment is characterized by that the wavelength monitor 39 is disposed in front of the light-emitting device 2 (or rightward as viewed in FIG. 6). In FIG. 6, reference numeral 43 denotes a photodiode for monitoring the optical output of the light-emitting device 2.

The wavelength monitor 39 includes a beam splitting member which consists of a first half-mirror (or first beam splitting member) 40a and a second half-mirror (or second beam splitting member) 40b. These half-mirrors are disposed in series along the Z-axis direction with a predetermined pacing.

The first half-mirror 40a divides a laser beam outputted from the light-emitting device 2 into two laser beam portions, one of these laser beam portions being directed in the first direction (or X-axis direction) on the side of the first light-receiving device 5 while the other beam portion being oriented in the second direction (or Z-axis direction) on the side of the second half-mirror 40b. The second half-mirror 40b divides a laser beam outputted from the first half-mirror 40a into two laser beam portions, one of these laser beam portions being directed in the third direction (or X-axis direction) on the side of the second light-receiving device 6 while the other beam portion being oriented in the fourth direction (or Z-axis direction).

The laser beam portion diverted by the second half-mirror 40b in the fourth direction (or Z-axis direction) enters the optical fiber 3 held by the ferrule 24 through the window portion 22 and condensing lens 37 before it is externally delivered.

The operation of the fourth embodiment is similar to that of the first embodiment. Although in the example of FIG. 6, the first and second light-receiving devices 5, 6 are fixedly mounted separately on different PD carriers 41 and 42, they may be mounted on the same mounting member.

(Fifth Embodiment)

FIG. 7 illustrates a WDM optical transmission device usable in a wavelength division multiplexing communication system relating to the fifth embodiment of the present invention.

As shown in FIG. 7, the wavelength division multiplexing communication system comprises a plurality of optical transmitters 31, a multiplexer 32 for wavelength multiplexing optical signals of plural channels sent from the optical transmitters 31, a plurality of optical amplifiers 33 connected in series to one another for amplifying and relaying the optical signals wavelength multiplexed by the multiplexer 32, a multiplexer 34 for wavelength separating the amplified optical signals from the optical amplifiers 33 for each channel, and a plurality of optical receivers 35 for receiving the optical signals wavelength separated by the multiplexer 34. The WDM optical transmission device 36 relating to the fifth embodiment of the present invention includes a plurality of optical transmitters 31 constructed according to the first and second embodiments and adapted to wavelength multiplex and send the optical signals outputted from these optical transmitters 31. Therefore, the optical signals transmitted from the optical transmitters 31 can be stabilized in wavelength. This enables the dense WDM system to be configured with increased reliability.

(Sixth Embodiment)

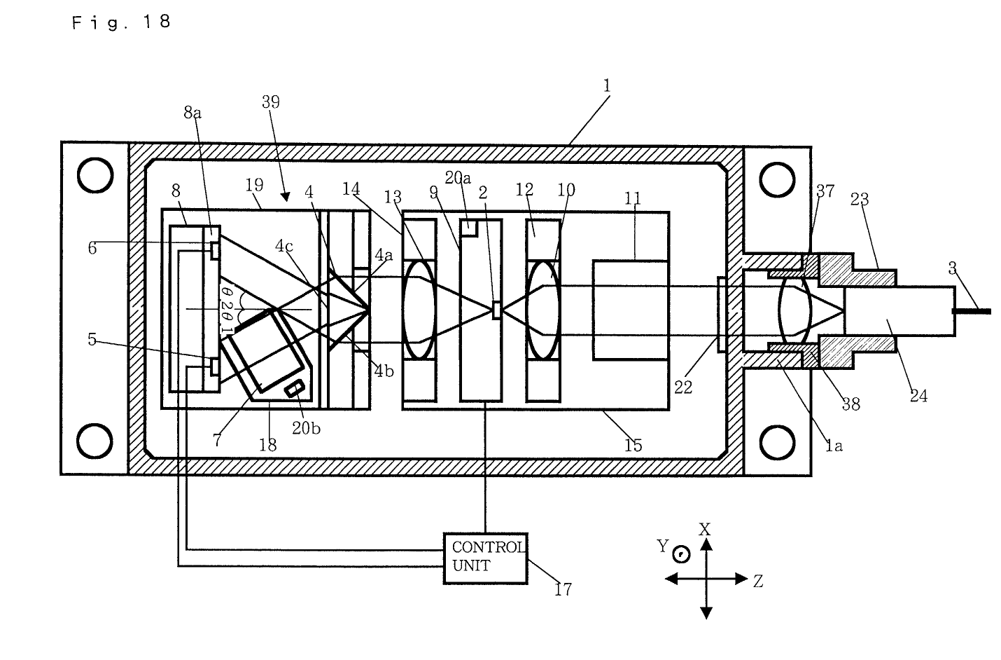

FIG. 18 is a plan view of an optical module according to the sixth embodiment of the present invention. The functions of the second and third temperature sensors in the wavelength monitor are performed by the thermistor of 20b.

An optical filter mounted in the optical module according to this embodiment is an etalon filter of quartz which has the opposite end face coated with anti-reflection films. The etalon filter is designed to have its wavelength transmission characteristic cycle of 50 GHz (400 pm) at 25° C. The etalon filter is mounted on a metal holder which is fixedly mounted on a base above a temperature regulator through YAG laser welding.

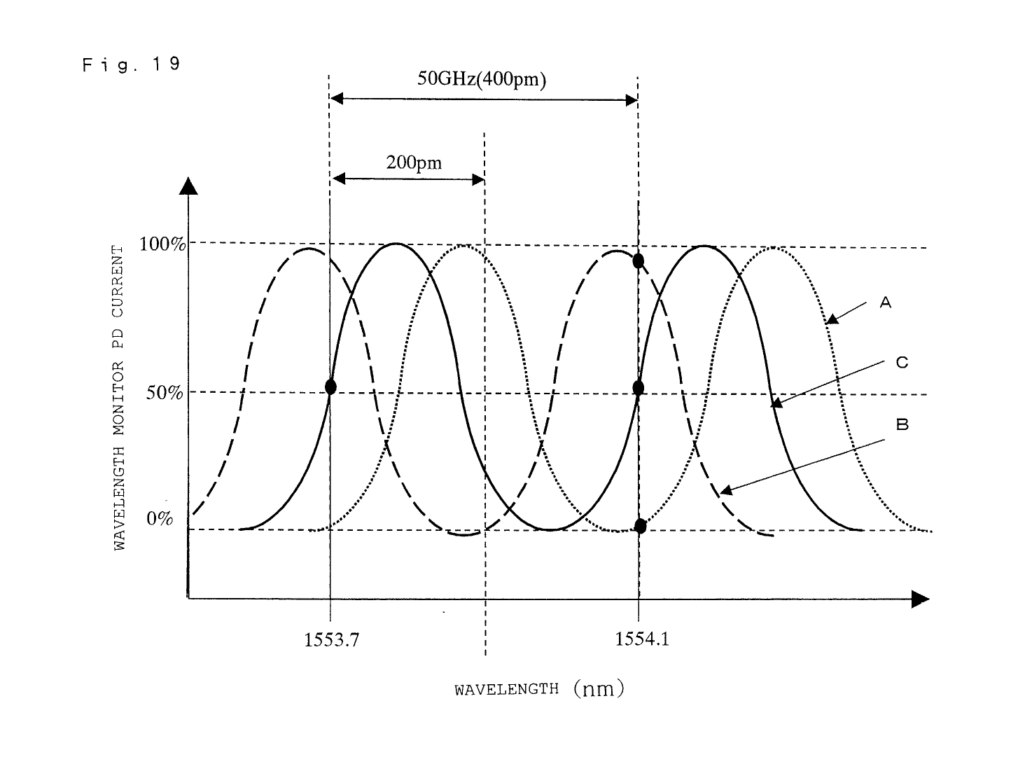

However, the wavelength transmission characteristic may be as shown by broken line A in FIG. 19 due to dispersion in the characteristic of the respective filter or due to positional shift created when the optical filter is fixed. In such a case, if the laser beam is to be controlled, for example, into a wavelength of 1554.1 nm used in the WDM communication, the etalon filter will not substantially transmit the laser beam in the region of wavelength near 1554.1 nm. Even if the wavelength of the laser beam varies, the changed amount of the transmitted light cannot substantially be sensed since it is too little. If the temperature dependency in the wavelength transmission characteristic of the etalon is used to control the normal temperature (25° C.) maintained in the temperature regulator into 16° C., however, the wavelength transmission characteristic of the etalon filter can be changed as shown by C. If the oscillation wavelength of the laser beam changes near the wavelength of 1554.1 nm, therefore, the amount of the transmitted light will greatly be changed. Thus, the change of wavelength can easily be detected to control the oscillation wavelength of the laser device.

Where the etalon filter placed has such a characteristic as shown by B in FIG. 19 at 25° C., the characteristic of transmission has the maximum peak near the wavelength of 1554.1 nm. It is thus similarly difficult to detect the changed amount of light corresponding to the changed wavelength of the laser beam. This makes the control of the oscillation wavelength of the laser device difficult. In this case, the wavelength transmission characteristic C of the etalon filter can similarly be provided by maintaining the temperature of the temperature regulator at 40° C. Therefore, the changed wavelength can easily be detected.

In such a manner, the changed amount of the light transmitted through the optical filter in connection with the changed wavelength of the laser beam can be increased and easily detected by the light receiving device by properly controlling the temperature through the control wavelength of the laser beam such that the optical transmission of the optical filter will not be maximized or minimized.

(Modification of the Sixth Embodiment)

In the sixth embodiment, it may be required that the oscillation wavelength of the laser device is controlled into any other wavelength used in the WDM light communication. If the oscillation wavelength of the laser device is being controlled by the temperature thereof, the control temperature of said first temperature adjustment unit for adjusting the temperature of the laser device varies depending on the required oscillation wavelength. The wavelength monitor is housed within the package having a laser device in which, for example, its oscillation wavelength is 1554.1 nm when the first temperature adjustment unit is at 40° C. and 1553.7 nm when at 5° C. In this case, the control temperature of said second temperature regulator for controlling the temperature of the optical filter can be changed depending on the required monitor wavelength.

When the first temperature adjustment unit is controlled into 40° C. and if its required laser oscillation wavelength is 1554.1 nm, the center of the wavelength transmission characteristic slope in the etalon filter can be located near 1554.1 nm by maintaining the etalon having its wavelength characteristic shown by B in FIG. 19 at 40° C. On the other hand, when the first temperature adjustment unit is controlled into 5° C. and if its required laser oscillation wavelength is 1553.7 nm, the center of the wavelength transmission characteristic slope in the etalon filter can be located near 1553.7 nm by maintaining the etalon having its wavelength characteristic shown by B in FIG. 19 at 0° C. At this time, the center of the wavelength transmission characteristic slope in the etalon filter can be located near 1553.7 nm by maintaining the etalon at 40° C. because the cycle of the wavelength transmission characteristic in the etalon filter is designed to be about 50 GHz (400 pm). Thus, the power consumption in the temperature regulators can be reduced by changing the control temperature of the wavelength monitor depending on the temperature of the laser section and by controlling the temperatures of the first and second temperature regulators at levels nearer each other. This can also reduce the influence from the ambient temperature. As a result, the temperatures of the laser section and wavelength monitor can more stably be maintained.

The present invention is not limited to the aforementioned embodiments, but may be carried out in any of various other forms without departing from the spirit and scope of the invention as claimed in the accompanying claims.

1. An optical transmitter comprising:
a light-emitting device for outputting a laser beam;
a first temperature adjustment unit for adjusting the temperature of said light-emitting device;
a wavelength monitor for receiving and monitoring the laser beam from said light-emitting device after it has passed through an optical filter; and
a second temperature adjustment unit for adjusting the temperature of said wavelength monitor,
wherein said optical filter is a optical interferometer formed of a medium which has its index of refraction variable depending on temperature and wherein the temperature of said optical filter is controlled by said second temperature adjustment unit into a temperature at which the optical transmission thereof at a predetermined wavelength will not coincide with either of the maximum or minimum level.

2. The optical transmitter of claim 1 wherein said optical filter is a optical interferometer formed of a medium which has its index of refraction variable depending on temperature and wherein the temperature of said optical filter is controlled by said second temperature adjustment unit such that the optical transmission thereof at a predetermined wavelength is between 20% and 80% of the maximum level.

3. The optical transmitter of claim 1 wherein said predetermined wavelength is a wavelength of the laser beam emitted from said light-emitting device, said wavelength being used in the WDM light communication.

4. The optical transmitter of claim 1 wherein the temperature of said wavelength monitor is determined depending on, among several types of previously provided control temperatures, the temperature of the first temperature adjustment unit for adjusting the temperature of said light-emitting device.

5. The optical transmitter of claim 1 wherein the wavelength of the laser beam emitted from said light-emitting device is locked by controlling the temperature of said light-emitting device based on a signal from said wavelength monitor.

6. An optical module comprising:
a light-emitting device for outputting a laser beam;
a first temperature adjustment unit for adjusting the temperature of said light-emitting device;
a wavelength monitor for receiving and monitoring the laser beam from said light-emitting device after it has passed through an optical filter;
a second temperature adjustment unit for adjusting the temperature of said wavelength monitor; and
a package housing all the components mentioned above,
wherein said optical filter is a optical interferometer formed of a medium which has its index of refraction variable depending on temperature and wherein the temperature of said optical filter is controlled by said second temperature adjustment unit into a temperature at which the optical transmission thereof at a predetermined wavelength will not coincide with either of the maximum or minimum level.

7. An optical module comprising:
a light-emitting device for outputting a laser beam;
a first temperature sensor disposed in proximity to said light-emitting device for sensing the temperature in said light-emitting device;
a first temperature adjustment unit for adjusting the temperature of said light-emitting device;
a wavelength monitor for receiving and monitoring the laser beam from said light-emitting device after it has passed through an optical filter;
a second temperature sensor disposed in said wavelength monitor for sensing the temperature in said wavelength monitor;
a second temperature adjustment unit for adjusting the temperature in said wavelength monitor based on a value from said second temperature sensor; and
a third temperature sensor disposed directly in or in proximity to said optical filter for sensing the temperature in said optical filter.

8. The optical module of claim 7 wherein said second temperature adjustment unit is controlled based on values from the second and third temperature sensors.

9. An optical transmitter comprising:
an optical module including
a light-emitting device for outputting a laser beam,
a first temperature sensor disposed in proximity to said light-emitting device for sensing the temperature in said light-emitting device,
a first temperature adjustment unit for adjusting the temperature of said light-emitting device;
a wavelength monitor for receiving and monitoring the laser beam from said light-emitting device after it has passed through an optical filter,
a second temperature sensor disposed in said wavelength monitor for sensing the temperature in said wavelength monitor,
a second temperature adjustment unit for adjusting the temperature in said wavelength monitor based on a value from said second temperature sensor, and
a third temperature sensor disposed directly in or in proximity to said optical filter for sensing the temperature in said optical filter;
a control unit for locking the oscillation wavelength of the laser beam outputted from said light-emitting device at a predetermined lock wavelength, based on a signal outputted from said wavelength monitor; and
a correction unit for outputting a correction signal toward said control unit based on the temperature sensed by said third temperature sensor, said correction signal being used to instruct the correction of a shift in said lock wavelength in connection with the temperature characteristic of said optical filter.

10. The optical module of claim 7 wherein said second temperature sensor also functions as said third temperature sensor.

11. An optical transmitter comprising:
an optical module including
a light-emitting device for outputting a laser beam,
a first temperature sensor disposed in proximity to said light-emitting device for sensing the temperature in said light-emitting device,
a first temperature adjustment unit for adjusting the temperature of said light-emitting device;
a wavelength monitor for receiving and monitoring the laser beam from said light-emitting device after it has passed through an optical filter,
a second temperature sensor disposed in said wavelength monitor for sensing the temperature in said wavelength monitor,
a second temperature adjustment unit for adjusting the temperature in said wavelength monitor based on a value from said second temperature sensor, and
a third temperature sensor disposed directly in or in proximity to said optical filter for sensing the temperature in said optical filter, said second temperature sensor also functioning as said third temperature sensor;
a control unit for locking the oscillation wavelength of the laser beam outputted from said light-emitting device at a predetermined lock wavelength, based on a signal outputted from said wavelength monitor; and
a correction unit for outputting a correction signal toward said control unit based on the temperature sensed by said third temperature sensor, said correction signal being used to instruct the correction of a shift in said lock wavelength in connection with the temperature characteristic of said optical filter.

12. A WDM optical transmission device comprising:
a plurality of optical transmitters, each of said optical transmitters comprising:
a light-emitting device for outputting a laser beam;
a first temperature adjustment unit for adjusting the temperature in said light-emitting device;
a wavelength monitor for receiving and monitoring the laser beam from said light-emitting device after passed through an optical filter; and
a second temperature adjustment unit for adjusting the temperature in said wavelength monitor,
wherein said optical filter is a optical interferometer formed of a medium which has its index of refraction variable depending on temperature and wherein the temperature of said optical filter is controlled by said second temperature adjustment unit into a temperature at which the optical transmission thereof at a predetermined wavelength will not coincide with either of the maximum or minimum level
and wherein optical signals outputted from said optical transmitters are multiplexed and transmitted.

13. A WDM optical transmission device comprising:
a plurality of optical transmitters, each of said optical transmitters comprising:
an optical module including
a light-emitting device for outputting a laser beam,
a first temperature sensor disposed in proximity to said light-emitting device for sensing the temperature in said light-emitting device,
a first temperature adjustment unit for adjusting the temperature of said light-emitting device;
a wavelength monitor for receiving and monitoring the laser beam from said light-emitting device after it has passed through an optical filter,
a second temperature sensor disposed in said wavelength monitor for sensing the temperature in said wavelength monitor,
a second temperature adjustment unit for adjusting the temperature in said wavelength monitor based on a value from said second temperature sensor, and
a third temperature sensor disposed directly in or in proximity to said optical filter for sensing the temperature in said optical filter;
a control unit for locking the oscillation wavelength of the laser beam outputted from said light-emitting device at a predetermined lock wavelength, based on a signal outputted from said wavelength monitor; and
a correction unit for outputting a correction signal toward said control unit based on the temperature sensed by said third temperature sensor, said correction signal being used to instruct the correction of a shift in said lock wavelength in connection with the temperature characteristic of said optical filter,
wherein optical signals outputted from said optical transmitters are multiplexed and transmitted.

14. A WDM optical transmission device comprising:
a plurality of optical transmitters, each of said optical transmitters comprising:
an optical module including
a light-emitting device for outputting a laser beam,
a first temperature sensor disposed in proximity to said light-emitting device for sensing the temperature in said light-emitting device,
a first temperature adjustment unit for adjusting the temperature of said light-emitting device;
a wavelength monitor for receiving and monitoring the laser beam from said light-emitting device after it has passed through an optical filter,
a second temperature sensor disposed in said wavelength monitor for sensing the temperature in said wavelength monitor,
a second temperature adjustment unit for adjusting the temperature in said wavelength monitor based on a value from said second temperature sensor, and
a third temperature sensor disposed directly in or in proximity to said optical filter for sensing the temperature in said optical filter, said second temperature sensor also functioning as said third temperature sensor;
a control unit for locking the oscillation wavelength of the laser beam outputted from said light-emitting device at a predetermined lock wavelength, based on a signal outputted from said wavelength monitor; and
a correction unit for outputting a correction signal toward said control unit based on the temperature sensed by said third temperature sensor, said correction signal being used to instruct the correction of a shift in said lock wavelength in connection with the temperature characteristic of said optical filter,
wherein optical signals outputted from said optical transmitters are multiplexed and transmitted.
